(19) United States
(12) Patent Application Publication
(10) Pub. No.: US 2013/0308783 A1
(43) Pub. Date: Nov. 21, 2013

(54) NOISE LEVEL ALARM SYSTEM

(71) Applicants: HONG FU JIN PRECISION INDUSTRY (WUHAN) CO., LTD., (US); HON HAI PRECISION INDUSTRY CO., LTD., New Taipei (TW)

(72) Inventors: ZHI-YONG GAO, Wuhan (CN); TING-TING WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/780,059

(22) Filed: Feb. 28, 2013

(30) Foreign Application Priority Data
May 15, 2012 (CN) 201210149651.8

(51) Int. Cl. G08B 21/18

(52) U.S. Cl. CPC G08B 21/182
USPC 381/56

(57) ABSTRACT

A noise alarm system includes a sound gathering circuit, a amplifying circuit, a wave filtering circuit, a comparing circuit, and a alarm circuit. The sound gathering circuit gathers a sound signal. The sound signal includes a noise signal and other signals. The amplifying circuit amplifies the sound signal. The wave filtering circuit filters the other signals and output the noise signal. The comparing circuit has a reference voltage and outputs the noise signal to the alarm circuit after comparing the noise signal with the reference voltage. The alarm circuit switches on when the noise signal greater than the reference voltage.

### BACKGROUND

1. Technical Field

The present disclosure relates to alarm systems, and particularly to a noise level alarm system.

2. Description of Related Art

Noise level is limited in many fields, such as boot noise of computers and working noise of appliances. The noise levels should be tested before the computers and the appliances are shipped. Generally, the noise levels are tested under artificial conditions. However, there is a large margin of error between a tested result and the actual noise. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a noise level alarm system.

FIG. 2 is a circuit diagram of the noise level alarm system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

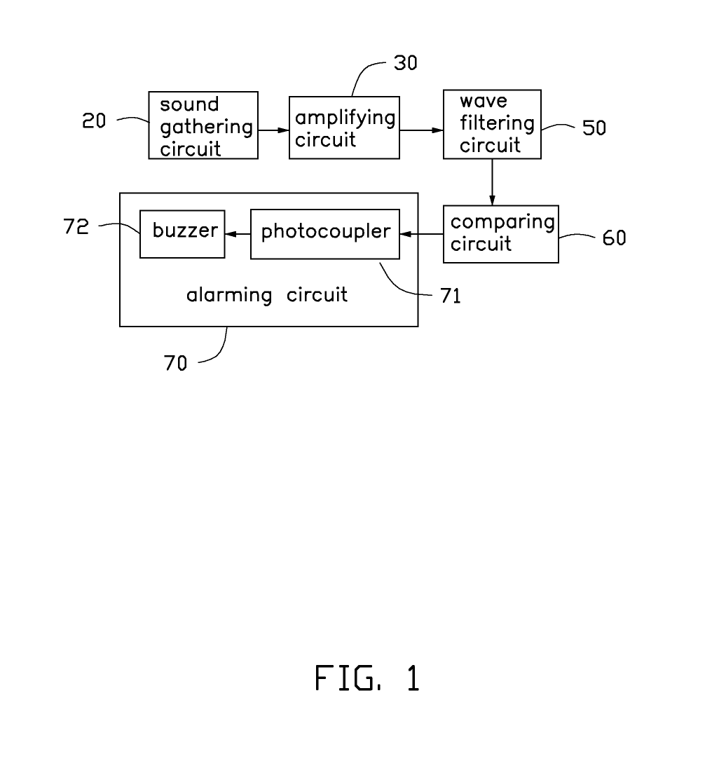

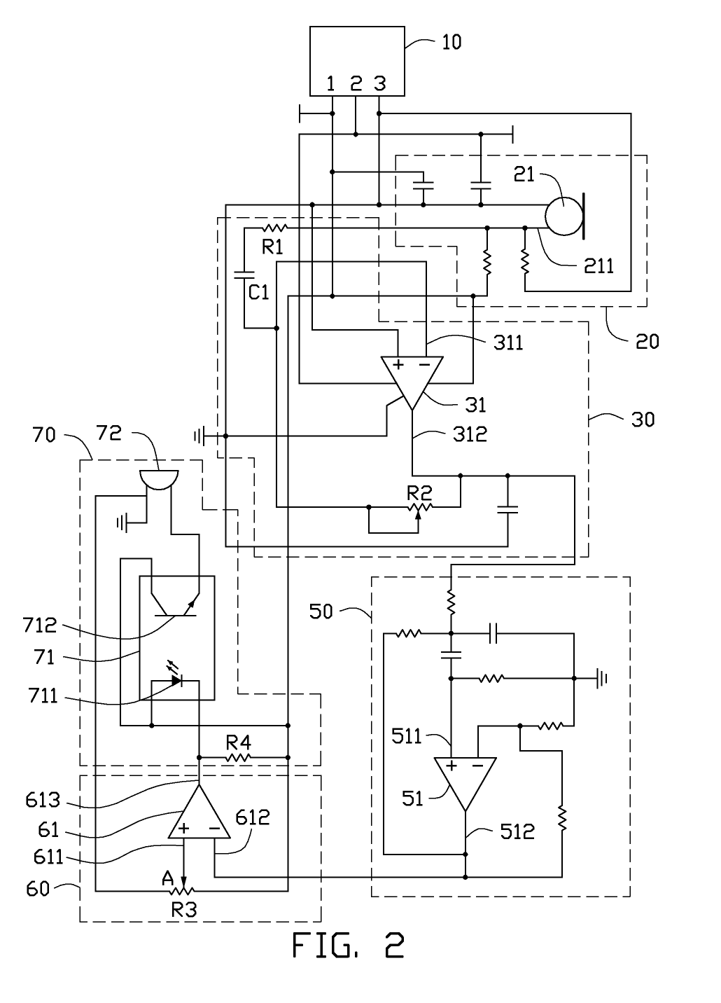

FIG. 1 and FIG. 2 are a noise level alarm system in accordance with an embodiment. The noise level alarm system includes a power supply 10, a sound gathering circuit 20, and an amplifying circuit 30, a wave filtering circuit 50, a comparing circuit 60, and an alarm circuit 70.

The power supply 10 includes a positive pole and a negative pole. The positive pole outputs a +5V voltage to supply a working voltage for the sound gathering circuit 20, the amplifying circuit 30, the wave filtering circuit 50, and the alarm circuit 70.

The sound gathering circuit 20 includes a sound collector 21. The sound collector 21 includes an audio output terminal 211. The sound collector 21 is used for gathering a sound signal and outputting the sound signal from the audio output terminal 211. The sound signal is an analog signal and includes a noise signal and other sound signals. In one embodiment, the sound collector 21 is a microphone.

The amplifying circuit 30 includes a first amplifier 31, a first resistor R1, a first capacitor C1, and an adjustable resistor R2. The first amplifier 31 includes a first negative terminal 311 and a first output terminal 312. The audio output terminal 211, the first resistor R1, the first capacitor C1, and the first negative terminal 311 are connected in series. The first output terminal 312 is connected to a first end of the adjustable resistor R2. A second end of the adjustable resistor R2 is connected to the first negative terminal 311. The amplifying circuit 30 is used for amplifying the sound signal. An amplifying multiple of the first amplifier 31 is equal to the ratio of a resistance of the adjustable resistor R2 to a resistance of the first resistor R1. The amplifying multiple of the first amplifier 31 can be adjusted by adjusting the resistance of the adjustable resistor R2. In one embodiment, the first amplifier 31 is a chip OP07.

The wave filtering circuit 50 includes a second amplifier 51. The second amplifier 51 includes a first positive terminal 511 and a second output terminal 512. The first output terminal 312 is connected to the first positive terminal 511. The wave filtering circuit 50 is an active band-pass filter circuit. The wave filtering circuit 50 is used for filtering other sound signal in the sound signal and outputting the noise signal from the second output terminal 512 amplified by the amplifying circuit 30. In one embodiment, the second amplifier 51 is a chip AD620.

The comparing circuit 60 includes a comparer 61 and a potentiometer R3. The comparer 61 includes a second positive terminal 611, a second negative terminal 612, and a third output terminal 613. A first end of the potentiometer R3 is connected to the positive pole of the power supply 10. A second end of the potentiometer R3 is grounded. The potentiometer R3 includes a node A. The voltage of the node A is a reference voltage of the comparer 61. The reference voltage can be adjusted by adjusting a position of the node A. When a voltage of the second negative terminal 612 is greater than the reference voltage, the third output terminal 613 outputs a low level, such as logic 0. When the voltage of the second negative terminal 612 is smaller than the reference voltage, the third output terminal 613 outputs a high level, such as logic 1. Thus, when the noise level signal is greater than a reference noise level signal, the third output terminal 613 outputs a low level, while when the noise level signal is smaller than the reference noise level signal, the third output terminal 613 outputs a high level.

The alarm circuit 70 includes a photocoupler 71 and a buzzer 72. The photocoupler 71 includes a light diode 711 and a triode 712. A first end of the buzzer 72 is grounded, and a second end of the buzzer 72 is connected to an emitter of the triode 712. A positive end of the light diode 711 is connected to the positive pole of the power supply 10 via a pull-up resistor R4. A negative end of the light diode 711 is grounded. When the third output terminal 613 outputs the high level, the light diode 711 is off, and the alarm circuit 70 is off. When the third output terminal 613 outputs the low level, the light diode 711 is switched on and drives the triode 712 to switch on. Then the triode 712 drives the buzzer 72 to sound to point out that the noise signal is greater than the reference value.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A noise level alarm system comprising:
a sound gathering circuit gathering a sound signal, and the sound signal comprising a noise signal and other signals;
an amplifying circuit amplifying the sound signal;
a wave filtering circuit filtering the other signals and outputting the noise signal;
a comparing circuit pre-setting a reference voltage; and
an alarm circuit;
wherein the comparing circuit outputs the noise signal to the alarm circuit after comparing the noise signal with the reference voltage; and the alarm circuit alarms when the noise signal is greater than the reference voltage.

2. The noise level alarm system of claim 1, wherein the sound gathering circuit comprises a microphone, and the microphone comprises an audio output terminal for outputting the sound signal; the amplifying circuit comprises a first amplifier, a first resistor, a first capacitor, and an adjustable resistor; the first amplifier comprises a first negative terminal and a first output terminal; the audio output terminal, the first resistor, the first capacitor, and the first negative terminal are connected in series; and the first output terminal outputs an amplified sound signal.

3. The noise level alarm system of claim 2, wherein the first outputting terminal is connected to a first end of the adjustable resistor; and a second end of the adjustable resistor is connected to the first negative terminal.

4. The noise level alarm system of claim 2, wherein an amplifying multiple of the first amplifier is equal to the ratio of a resistance of the adjustable resistor to a resistance of the first resistor.

5. The noise level alarm system of claim 2, wherein the wave filtering circuit comprises a second amplifier; the second amplifier comprises a first positive terminal and a second output terminal; the first output terminal is connected to the first positive terminal; and the second output terminal outputs an amplified noise signal.

6. The noise level alarm system of claim 5, wherein the wave filtering circuit is an active band-pass filter circuit.

7. The noise level alarm system of claim 5, wherein the comparing circuit comprises a comparer and a potentiometer; the comparer comprises a second positive terminal, a second negative terminal, and a third output terminal; the potentiometer comprises a node; the second positive terminal is connected to the node; a voltage of the node is the reference voltage of the comparing circuit; the second negative terminal is connected to the second output terminal; when a voltage of the amplified noise signal is greater than the reference voltage, the third output terminal outputs a low level signal; and when the voltage of the amplified noise signal is smaller than the reference voltage, the third output terminal outputs a high level signal.

8. The noise level alarm system of claim 7, wherein the alarm circuit comprises a photocoupler, a buzzer, and a pull-up resistor; the photocoupler comprises a positive end and a negative end; the negative end is connected to the third output terminal; and the positive end is connected to a positive pole of a power supply via the pull-up resistor.

9. The noise level alarm system of claim 8, wherein when the third outputting terminal outputs the high level signal, the photocoupler is off, and the buzzer is off; and when the third outputting terminal outputs the low level signal, the photocoupler is switched on and drives the drives the buzzer to alarm.

10. A noise level alarm system, comprising:
a sound gathering circuit gathering a sound signal, and the sound signal comprising a noise signal and other signals;
an amplifying circuit amplifying the sound signal;
a wave filtering circuit filtering the other signals and outputting the noise signal;
a comparing circuit pre-setting a reference voltage and comparing the noise signal with the reference voltage; and
an alarm circuit;
wherein the comparing circuit outputs a low level signal or a high level signal to the alarm circuit; and the alarm circuit alarms when the comparing circuit outputs the low level signal.

11. The noise level alarm system of claim 10, wherein the sound gathering circuit comprises a microphone, and the microphone comprises an audio output terminal for outputting the sound signal; the amplifying circuit comprises a first amplifier, a first resistor, a first capacitor, and an adjustable resistor; the first amplifier comprises a first negative terminal and a first output terminal; the audio output terminal, the first resistor, the first capacitor, and the first negative terminal are connected in series; and the first output terminal outputs an amplified sound signal.

12. The noise level alarm system of claim 11, wherein the first outputting terminal is connected to a first end of the adjustable resistor; and a second end of the adjustable resistor is connected to the first negative terminal.

13. The noise level alarm system of claim 11, wherein an amplifying multiple of the first amplifier is equal to the ratio of a resistance of the adjustable resistor to a resistance of the first resistor.

14. The noise level alarm system of claim 11, wherein the wave filtering circuit comprises a second amplifier; the second amplifier comprises a first positive terminal and a second output terminal; the first output terminal is connected to the first positive terminal; and the second output terminal outputs an amplified noise signal.

15. The noise level alarm system of claim 14, wherein the wave filtering circuit is an active band-pass filter circuit.

16. The noise level alarm system of claim 14, wherein the comparing circuit comprises a comparer and a potentiometer; the comparer comprises a second positive terminal, a second negative terminal, and a third output terminal; the potentiometer comprises a node; the second positive terminal is connected to the node; a voltage of the node is the reference voltage of the comparing circuit; the second negative terminal is connected to the second output terminal; when a voltage of the amplified noise signal is greater than the reference voltage, the third output terminal outputs the low level signal; and when the voltage of the amplified noise signal is smaller than the reference voltage, the third output terminal outputs the high level signal.

17. The noise level alarm system of claim 16, wherein the alarm circuit comprises a photocoupler, a buzzer, and a pull-up resistor; the photocoupler comprises a positive end and a negative end; the negative end is connected to the third output terminal; and the positive end is connected to a positive pole of a power supply via the pull-up resistor.

18. The noise level alarm system of claim 17, wherein when the third outputting terminal outputs the high level signal, the photocoupler is off, and the buzzer is off; and when the third outputting terminal outputs the low level signal, the photocoupler is switched on and drives the drives the buzzer to alarm.
